(19) United States
(12) Patent Application Publication
(10) Pub. No.: US 2009/0228793 A1
(43) Pub. Date: Sep. 10, 2009

(54) DISPLAY APPARATUS DISPLAY SYSTEM AND CONTROL METHOD OF THE SAME

(75) Inventors: Young-joong NOH, Suwon-si (KR); Woo-jung KIM, Suwon-si (KR); Dae-hyun JANG, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/337,085

(22) Filed: Dec. 17, 2008

(30) Foreign Application Priority Data
Mar. 10, 2008 (KR) 10-2008-0021893

(51) Int. Cl. G06F 3/048

(52) U.S. Cl. 715/703

(57) ABSTRACT

A display apparatus includes a display unit, a storage unit which stores a zone name and standard time information corresponding to the zone name, a user interface (UI) generator which generates a time information image, and a controller which receives local real-time information from an external source, calculates a time corresponding to a selected zone based on the local real-time information and the standard time information, and controls the UI generator to generate the time information image containing the calculated time to be displayed on the display unit.

### CROSS-REFERENCE TO RELATED APPLICATION

This application claims priority from Korean Patent Application No. 10-2008-0021893, filed on Mar. 10, 2008 in the Korean Intellectual Property Office, the disclosure of which is incorporated herein by reference in its entirety.

### BACKGROUND OF INVENTION

1. Field of Invention

Apparatuses and methods consistent with the present invention relate to a display apparatus, a display system and a control method of the same, and more particularly, to a display apparatus capable of displaying time, a display system and a control method of the same.

2. Description of the Related Art

A display displays an image based on a broadcasting signal transmitted from a broadcasting station or a video signal input from an external video source. Besides such a function of displaying an image, the display apparatus has recently been utilized as a high-tech communication terminal, and thus various functions are being added thereto. Also, the display apparatus includes an internal clock and provides time information to a user.

Meanwhile, world local times and standard times are defined depending on Greenwich Mean Time (GMT) that is measured from the Greenwich meridian line at the royal observatory in Greenwich. In general, standard times at every 15° longitude interval differ from each preceding and following zone by one hour. The standard time becomes one hour later at each 15° longitude interval east and one hour earlier at each 15° longitude interval west. For example, the standard time in Korea is 9 hours ahead of the standard time in Greenwich. Thus, if standard time information and current time in a certain time zone are given, current time in other time zones can be calculated.

### SUMMARY OF THE INVENTION

The present invention provides a display apparatus, a display system and a control method of the same, which can display exact world time to be intuitively apprehended by a user.

According to an aspect of the present invention, there is provided a display apparatus with a display unit, comprising: a storage unit which stores a predetermined zone name and standard time information corresponding to the zone name; a user interface (UI) generator which generates a time information image; and a controller which receives from an external source local real-time information when receiving a selection signal for selecting a zone, calculates a time corresponding to a selected zone on the basis of the local real-time information and the standard time information, and controls the UI generator to generate the time information image containing the calculated time to be displayed on the display unit.

The time information image may comprise a world map, and time information displayed on the world map.

The time information image may comprise a time bar movable on the world map and indicating a zone having the same standard time information.

The time bar may be positioned in a selected zone when receiving the selection signal.

The time information image may further comprise a zone information item showing at least one zone name belonging to the time bar and a time corresponding to the zone name.

The time information image may comprise a moving item for moving the time bar.

The time information image may further comprise a local time item showing the local real-time information.

The display apparatus may further comprise a user input unit to generate a control signal to display the time information image on the display unit.

The control signal may be received while the display unit does not display an image.

The display apparatus may further comprise a touch panel internally or externally provided in the display unit to input the selection signal.

The local real-time information may be received from an external server.

The display apparatus may be connected to the external server through a wire or wireless local area network (LAN).

According to another aspect of the present invention, there is provided a display apparatus with a display unit, comprising: a storage unit which stores a predetermined zone name and a standard time information corresponding to the zone name; a UI generator which generates a world map image containing time information; and a controller which calculates a time corresponding to a selected zone on the basis of local real-time information and the standard time information when receiving a selection signal, and controls the UI generator to display the world map image containing the calculated time on the display unit.

According to another aspect of the present invention, there is provided a display system comprising: a server which has local real-time information; and a display apparatus which comprises a display unit, a storage unit storing a predetermined zone name and standard time information corresponding to the zone name, and a controller that receives the local real-time information from the server when receiving a selection signal for selecting a zone, calculates a time corresponding to a selected zone on the basis of the local real-time information and the standard time information, and controls the UI generator to display time information image containing the calculated time on the display unit.

The controller may request the standard time information corresponding to the selected zone from the server if the standard time information corresponding to the selected zone is not stored in the storage unit.

The server and the display apparatus may be connected through a wired or wireless LAN.

According to another aspect of the present invention, there is provided a method of controlling a display apparatus comprising a display unit, and a storage unit storing a predetermined zone name and standard time information corresponding to the zone name, the method comprising: receiving a selection signal for selecting a zone; receiving local real-time information from an outside source; calculating a time corresponding to a selected zone on the basis of the local real-time information and the standard time information; and displaying a time information image containing the calculated time on the display unit.

The time information image may comprise a world map, and time information displayed on the world map.

The method may further comprise receiving a control signal to display the time information image on the display unit.

The time information image may comprise a time bar movable on the world map and indicating a zone having the same standard time information, and the method may further comprise positioning the time bar in the selected zone when receiving the selection signal.

The control signal may be received while the display unit does not display an image.

### BRIEF DESCRIPTION OF THE DRAWINGS

The above and/or other aspects of the present invention will become apparent and more readily appreciated from the following description of exemplary embodiments, taken in conjunction with the accompanying drawings, in which:

FIG. 1 is a block diagram of a display apparatus according to an exemplary embodiment of the present invention;

FIG. 2 shows a time information image in the display apparatus of FIG. 1;

FIG. 3 is a block diagram of a display apparatus according to another exemplary embodiment of the present invention;

FIG. 4 is a flowchart of controlling the display apparatus according to another exemplary embodiment of the present invention; and

FIG. 5 is a block diagram of a display apparatus according to another exemplary embodiment of the present invention.

### DETAILED DESCRIPTION OF EXEMPLARY EMBODIMENTS OF THE INVENTION

Reference will now be made in detail to exemplary embodiments of the present invention, examples of which are illustrated in the accompanying drawings, wherein like reference numerals refer to like elements throughout. The exemplary embodiments are described below so as to explain the present invention by referring to the figures.

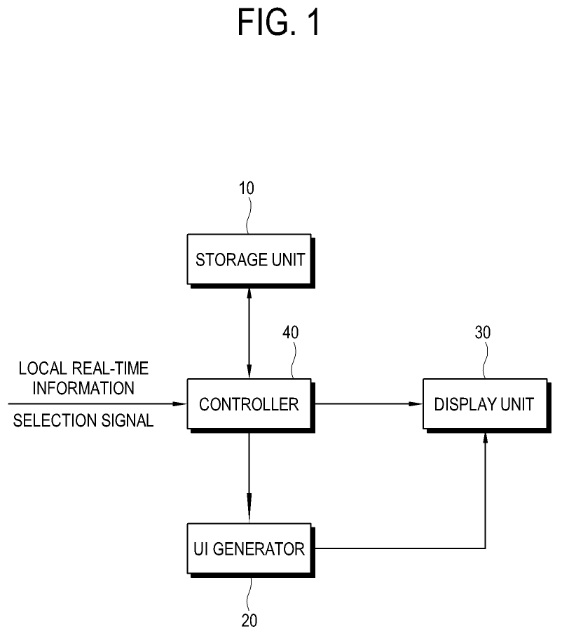

FIG. 1 is a block diagram of a display apparatus according to a first exemplary embodiment of the present invention. As shown therein, the display apparatus includes a storage unit 10, a UI generator 20, a display unit 30, and a controller 40 controlling them. The display apparatus according to the present invention may be installed in a place such as a hotel, an airport, etc., where world business is conducted and a foreigner makes frequent visits.

The storage unit 10 stores standard time information corresponding to a predetermined zone and a zone name. Here, the zone name may include the names of countries or cities, and the standard time information may mean GMT. World times at regular intervals of longitude, i.e., at every 15° longitude with respect to the Greenwich meridian line at the royal observatory in Greenwich differ by one hour. For example, the standard time in Korea uses GMT+9 corresponding to 135° east longitude, i.e., the standard time in Korea is 9 hours ahead of the standard time in Greenwich. The storage unit 10 may divide 24 hours into a predetermined number of standard times such as GMT+1, GMT+2, GMT+3, GMT+3:30, . . . , GMT+21, and stores the name of countries or cities corresponding to the standard times in the form of a look-up table. There is a difference of one hour or thirty minutes between the standard times. The storage unit 10 may be additionally provided for storing the standard times, or the standard times may be stored by an existing built-in flash memory of the display apparatus.

The UI generator 20 generates a time-information image containing time information, thereby providing a graphic interface to a user. In this exemplary embodiment, the time-information image contains a world map (to be described later) for showing local times all over the world.

The display unit 30 displays the time-information image generated by the UI generator 20. The display unit 30 may be a liquid crystal display (LCD) including liquid crystal, an organic light emitting display (OLED) including an organic light emitting layer, a plasma display panel (PDP), etc.

The controller 40 calculates time corresponding to a selected zone when receiving a selection signal for selecting the zone from all over the world, and controls the UI generator 20 to display the time-information image together with the calculated time on the display unit 30. Here, the controller 40 calculates a current time of the selected zone on the basis of local real-time information corresponding to a place where the display apparatus is currently located and the standard time information stored in the storage unit 10. A known method or algorithm may be applied to calculating the time of other zones on the basis of the local time information and the standard time information. According to an exemplary embodiment of the present invention, the local real-time information is received not from the inside the display apparatus, e.g., a timekeeper stored in a read only memory (ROM) of the display apparatus, but from an external source. If the time is calculated on the basis of the local time of the internal timekeeper, the calculated time may not be exact. For example, if the internal timekeeper has an error such as delayed operation or the like, the time is calculated on the basis of the local time with such an error, and thus the calculated time of the selected zone may not be exact. Therefore, the display apparatus according to an exemplary embodiment of the present invention calculates the time of the selected zone on the basis of the exact local real-time information received from the external source. Here, the external source is an external device, an external server or the like which can communicate with the display apparatus in a wired or wireless manner. The external device or the external server is capable of receiving exact real-time information through a satellite or a broadcasting station. If the display apparatus is located in a hotel, an airport, etc., the display apparatus can receive the local real-time information from a server provided in the hotel or the airport. At this time, the server and the display apparatus may be connected through a wired or wireless LAN. The controller 40 sets the current time of the internal timekeeper on the basis of the local real-time information when receiving the local real-time information. Thus, the internal timekeeper is set to the correct time.

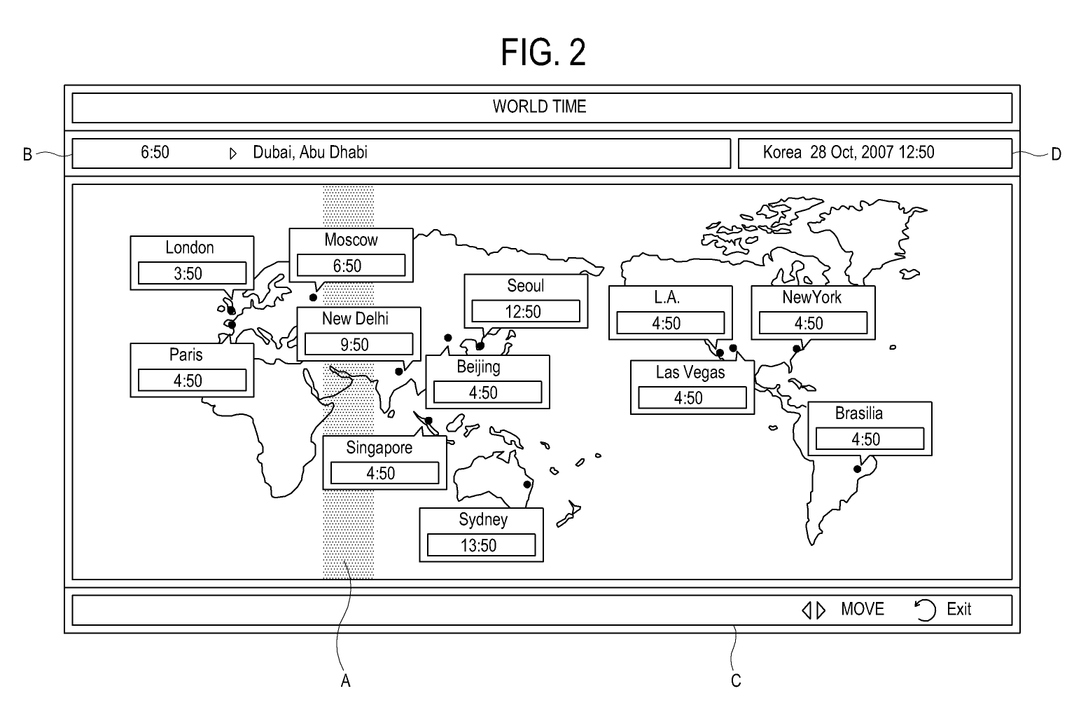

FIG. 2 shows a time information image generated by the UI generator 20. As described above, the time information image contains the world map. The world map shows time information (12:50, 4:50, 3:50, . . . ) about principal cities (Seoul, Paris, London, . . . ). The time information may be expressed by 24 hours or by dividing 24 hours into ante meridiem (A.M.) and post meridiem (P.M.). The time information is shown with regard to default zones. For example, the default zones include principal countries or cities of the continents.

The time information image includes a time bar A which is movable on the world map. The time bar A is displayed collecting the zones having the same standard time together, so that a user can apprehend the zones having the same standard time at a glance. The time bar A may be displayed as being overlapped with the zone having the same standard time or highlighted with a fluorescent color. Further, the time information image includes time information about the zone indicated by the time bar A, and zone information item B showing a name of at least one zone. The world map cannot show the time information about all zones since it has a limited space. Accordingly, a user can apprehend information about the zone having the same standard time with the selected zone through the zone information item B

The controller 40 controls the time bar A to be positioned in the selected zone when receiving the selection signal for selecting the zone. The time information image contains a selection bar C including a moving item “MOVE” for moving the time bar A and an exit item “EXIT” for exiting display of the time information image. The moving item “MOVE” includes arrow keys “ [symbol] ” for moving the time bar A left and right, and the time bar A moves depending on the arrow keys “ [symbol] .” As the time bar A moves, the time information and the name of the zone shown in the zone information item B are changed.

Further, a local time item D is provided aside of the zone information item B. The controller 40 controls the local time item D to show the local real-time information received from the external server.

Meanwhile, the time information image may be displayed through a full screen of the display unit 30, or partially displayed in the form of picture-in-picture (PIP) or picture-outside-picture (POP) on the display unit 30.

Thus, the display apparatus according to an exemplary embodiment of the present invention displays the world time through the world map so that a user can intuitively apprehend it. Further, a user can easily search or select the zone through the time bar A which is movable on the world map, and receive much time information through various item widows. Also, the controller 40 receives the local real-time information from the external source to more exactly calculate the time of the selected zone.

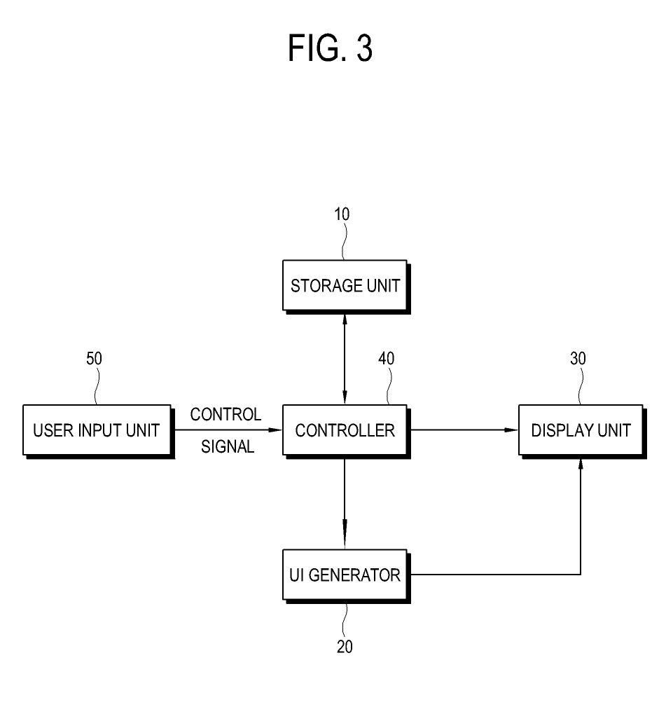

FIG. 3 is a block diagram of a display apparatus according to a second exemplary embodiment of the present invention. As shown therein, the display apparatus further includes a user input unit 50.

The user input unit 50 generates a control signal for controlling the display unit 30 to display the time information image, and outputs the control signal to the controller 40. While displaying an image based on a video signal such as a broadcasting signal on the display unit 30, the controller 40 stops displaying the image based on the broadcasting signal and controls the display unit 30 to display the time information image when receiving the control signal.

While the image based on the broadcasting signal or the like signal is not displayed, the controller 40 controls the UI generator 20 to display the time information image on the display unit 30 when receiving the control signal from the user input unit 50. If the display apparatus is a television, a user perceives the television as turned off when it displays no image even though power is supplied to the television. In this state in which the television is regarded as turned off, the display apparatus does not display an image but does receive the video signal. According to an exemplary embodiment of the present invention, the display unit 30 displays the time information image when receiving the control signal in the state that the image is not displayed. In other words, the time information image can be displayed through the control signal once without undergoing a plurality of stages that a user turns on the television and requests desired UI information. Further, if the display apparatus is a monitor connectable to a computer, the monitor displays the time information image when receiving the control signal as long as the monitor is turned on even though the monitor is disconnected from the computer and receives no video signal.

Further, the user input unit 50 may generate a selection signal to select the zone, and a user may change the default zone on the world map through the user input 50.

The user input unit 50 may be provided as a short cut key (a so-called hot key) placed in an external frame of the display apparatus. Through the short cut key, a user can directly reproduce the time information image by manipulating a button once without undergoing more complicated manipulations. The user input unit 50 may be achieved by a typical input unit such as a remote controller, a mouse, a keyboard or the like. The control signal may be generated by a certain button provided in the remote controller or the mouse, or by a plurality of key manipulations. Further, the user input unit 50 may be achieved by a touch panel internally or externally provided in the display unit 30. In this case, a user performs preset gestures on the touch panel 30 to display the world map, and easily moves the time bar A by touching a predetermined region on the world map.

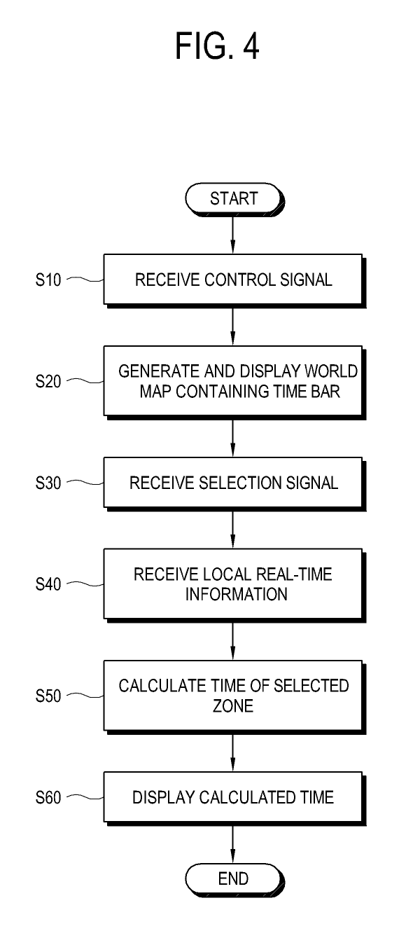

FIG. 4 is a flowchart of controlling the display apparatus according to the second exemplary embodiment of the present invention. Referring to FIG. 4, a method of displaying the world time is as follows.

First, the display apparatus receives the control signal that requests the time information image to be displayed (S10). The control signal makes the display unit 30 display the time information image regardless of whether the video signal is currently displayed as the image.

The controller 40 controls the display unit 30 to display the world map and the time information image containing time information on the world map (S20). At this time, the time information image includes a time bar A movable on the world map and indicating the zones having the same standard time, a zone information item B, a moving item, a local time item D, etc.

Then, when a user selects a certain zone and the display apparatus receives the selection signal (S30), the controller 40 receives the local real-time information from the external source (S40).

Then, the time corresponding to the selected zone is calculated on the basis of the local real-time information and the standard time information stored in the storage unit 10 (S50).

Lastly, the calculated time is displayed on the corresponding zone on the world map (S60). When the zone is selected, the time bar A moves to the selected zone, so that the calculated time is also displayed on the zone information item B.

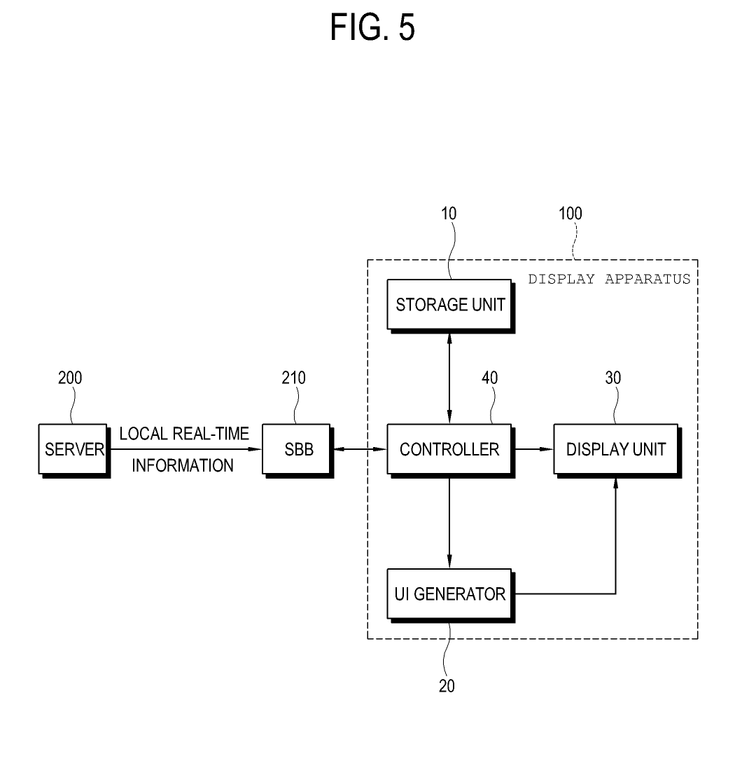

FIG. 5 is a block diagram of a display apparatus according to a third exemplary embodiment of the present invention.

As shown therein, the display system includes a display apparatus 100 and a server 200. Further, a set back box (SBB) 210 is provided as a signal transmission medium between the display apparatus 100 and the server 200. The display apparatus 100 corresponds to the display apparatus of FIG. 1 and has the same or similar configuration as described above.

The server 200 is provided in a place such as an airport, a hotel, etc., and is connected to the display apparatus 100 through a wired or wireless LAN. The server 200 provides various information containing the local real-time information to the display apparatus 100 according to requests of the display apparatus 100.

The display apparatus 100 requests the local real-time information from the server 200 when receiving the selection signal for selecting the zone, and calculates the time corresponding to the selected zone on the basis of the local real-time information from the server 200.

The server 200 includes a storage unit to store a name of a zone corresponding to the standard time information. The display apparatus 100 stores the minimum number of names of the zones corresponding to the standard time and other detailed zones are stored in the server 200, so that capacity of the storage unit 10 in the display apparatus 100 can be reduced. If the name of the zone selected by a user is not stored in the storage unit 10 of the display apparatus 100, the display apparatus 100 requests the standard time information about the selected zone from the server 200 and then the server 200 sends the standard time information about the corresponding zone to the display apparatus 100.

According to an exemplary embodiment of the present invention, the world map is used to show the time information about the zones all over the world to be intuitively apprehended by a user, and the local real-time information is received from the outside to offer a user the exact time information.

As described above, the present invention provides a display apparatus, a display system and a control method of the same, in which information about world time is more intuitively apprehended by a user and the user can easily select and search a zone.

Further, the present invention provides a display apparatus, a display system and a control method of the same, in which exact time information about zones all over the world is provided.

Also, the present invention provides a display apparatus, a display system and a control method of the same, in which capacity of a storage unit is reduced.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. A display apparatus, comprising:
a display unit;
a storage unit which stores a zone name and standard time information corresponding to the zone name;
a user interface (UI) generator which generates a time information image; and
a controller which receives local real-time information from an external source, calculates a time corresponding to a selected zone based on the local real-time information and the standard time information, and controls the UI generator to generate the time information image containing the calculated time to be displayed on the display unit.

2. The display apparatus according to claim 1, wherein the time information image comprises a world map and time information displayed on the world map.

3. The display apparatus according to claim 2, wherein the time information image further comprises a time bar movable on the world map and indicating a zone having same standard time information.

4. The display apparatus according to claim 3, wherein the time bar is positioned in the selected zone when receiving the selection signal.

5. The display apparatus according to claim 3, wherein the time information image further comprises a zone information item showing at least one zone name belong to the time bar and a time corresponding to the zone name.

6. The display apparatus according to claim 3, wherein the time information image further comprises a moving item for moving the time bar.

7. The display apparatus according to claim 2, wherein the time information image further comprises a local time item showing the local real-time information.

8. The display apparatus according to claim 1, further comprising a user input unit which generates a control signal to display the time information image on the display unit.

9. The display apparatus according to claim 8, wherein the control signal is received while the display unit does not display an image.

10. The display apparatus according to claim 1, further comprising a touch panel internally or externally provided in the display unit to input a selection signal indicating the selected zone.

11. The display apparatus according to claim 1, wherein the local real-time information is received from an external server.

12. The display apparatus according to claim 11, wherein the local real-time information is received from the external server through a local area network (LAN).

13. A display apparatus, comprising:
a display unit;
a storage unit which stores a predetermined zone name and standard time information corresponding to the zone name;
a user interface (UI) generator which generates a world map image containing time information; and
a controller which calculates a time corresponding to a selected zone based on local real-time information and the standard time information, and controls the UI generator to display the world map image containing the calculated time on the display unit.

14. A display system comprising:
a server which has local real-time information; and
a display apparatus comprising a display unit, a storage unit which stores a zone name and standard time information corresponding to the zone name, and a controller which receives the local real-time information from the server, calculates a time corresponding to a selected zone based on the local real-time information and the standard time information, and controls a user interface (UI) generator to display a time information image containing the calculated time on the display unit.

15. The display system according to claim 14, wherein the controller requests the standard time information corresponding to the selected zone from the server if the standard time information corresponding to the selected zone is not stored in the storage unit.

16. The display system according to claim 14, wherein the server and the display apparatus are connected through a local area network (LAN).

17. A method of controlling a display apparatus comprising a display unit and a storage unit storing a zone name and standard time information corresponding to the zone name, the method comprising:
receiving a selection signal for selecting a zone;
receiving local real-time information from an external source;
calculating a time corresponding to a selected zone based on the local real-time information and the standard time information; and
displaying a time information image containing the calculated time on the display unit.

18. The method according to claim 17, wherein the time information image comprises a world map and time information displayed on the world map.

19. The method according to claim 17, further comprising receiving a control signal to display the time information image on the display unit.

20. The method according to claim 18, wherein the time information image comprises a time bar movable on the world map and indicating a zone having same standard time information,
the method further comprising positioning the time bar in the selected zone when a selection signal is received.

21. The method according to claim 19, wherein the control signal is received while the display unit does not display an image.
